(19) United States
(12) Patent Application Publication
(10) Pub. No.: US 2021/0307256 A1
(43) Pub. Date: Oct. 7, 2021

(54) TYPE OF PLANTING POT

(71) Applicant: Ningbo Holby Agricultural Science & Technology Co., Ltd., Ningbo City (CN)

(72) Inventors: Israel HOLBY, Ningbo City (CN); Ji SHI, Ningbo City (CN); Yufei YAO, Ningbo City (CN); Yangkai JIANG, Ningbo City (CN)

(21) Appl. No.: 17/219,962

(22) Filed: Apr. 1, 2021

(30) Foreign Application Priority Data
Apr. 2, 2020 (CN) 202010255995.1

(51) Int. Cl. A01G 9/02

(52) U.S. Cl. CPC A01G 9/02; A01G 2009/003

(57) ABSTRACT

The planting pot comprises a pot wall and a pot bottom, wherein clamping assemblies are arranged at the bottom of the pot bottom. The clamping assemblies comprising a plurality of upper clamping members and a plurality of lower clamping members; the upper clamping members positioned above the lower upper clamping members. A plurality of clamping portions are arranged at the pot bottom, when the pot wall is assembled with the pot bottom, each of the upper clamping members is clamped with an upper side of one of the clamping portions and each of the lower clamping members are clamped with a lower side of one of the clamping portions. The pot bottom can be effectively clamped by the clamping pieces arranged on the pot wall of the planting pot, thus preventing the pot bottom from falling off when the planting pot is moved.

### CROSS-REFERENCE TO RELATED APPLICATIONS

This application claims priority to CN App. No. 202010255995.1, filed Apr. 2, 2020, which is incorporated by reference herein in its entirety.

### FIELD OF THE DISCLOSURE

The invention belongs to the technical field of cultivation containers, and specifically refers to a planting pot.

### BACKGROUND OF THE DISCLOSURE

Most crop planting pots cannot be disassembled and assembled, they often occupy a large space during transportation, and the pot wall is prone to being ruptured. The existing detachable planting pot includes a pot wall and a pot bottom, the pot bottom is provided with a slot, and the bottom of the pot wall is inserted into the slot to connect the pot wall to the pot bottom. However, the connection between the wall of the detachable planting pot and the bottom of the pot is not reliable. During transportation, the bottom of the planting pot may fall off due to the heavy substrate in the planting pot.

### SUMMARY OF THE INVENTION

To resolve the problems in the prior art that the detachable planting pot is likely to fall off the bottom of the pot during transportation, the present invention provides a planting pot.

The technical solution adopted by the present invention is: a planting pot, including a pot wall and a pot bottom, a bottom of the pot wall is provided with a clamping piece group; the clamping piece group includes a plurality of upper clamping members and a plurality of corresponding lower clamping members, and each of the upper clamping members is located above one of the lower clamping members.

The pot bottom is provided with a plurality of clamping portions for clamping with the pot wall, and when the pot wall and the pot bottom are assembled, each of the upper clamping members is clamped on an upper side of one of the clamping portions, and a corresponding one of the lower clamping members is clamped on a lower side of the clamping portion.

The pot wall includes a first wall plate, a second wall plate, and a third wall plate. The bottom of the first wall plate is connected to the top of the second wall plate, and the bottom of the second wall plate is connected to the top of the third wall plate. The plurality of upper clamping members are provided on the second wall plate, and the corresponding plurality of lower clamping members are provided on the third wall plate.

The third wall plate is inclined outward when the pot wall is flat, and the third wall plate is inclined outwardly when the pot wall surrounds the pot bottom. The angle of the outward inclination is smaller than the angle of the third wall plate in the flat state of the pot.

The upper clamping member is formed by the second wall plate protruding toward the inner side of the pot wall; the lower clamping member is formed by the third wall plate protruding toward the inner side of the pot wall.

The pot bottom includes a first plate and a support frame; the clamping portions are arranged at intervals on the peripheral side of the first plate, and the clamping portions are oriented towards external extension; the clamping portions are connected with the first plate to form a top plate, and the top of the support frame is connected with the top plate.

The pot wall is also provided with a plurality of shielding elements for shielding the gap between two adjacent clamping portions when the pot wall and the pot bottom are assembled. The number of the shielding elements is the same as the number of the clamping portions.

The support frame includes a plurality of support plate groups, the support plate group includes a first support plate, a second support plate, and a fourth support plate. The top of the first support plate is connected to the top plate, and the first end of the first support plate is connected to the second end of the fourth support plate, the second end of the first support plate is connected to the first end of the second support plate, the first end of the fourth support plate and the second end of the second support plate extend outwardly.

The upper part of each of the fourth support plate and/or the second support plate is provided with a mounting groove for one of the lower clamping members to pass through.

In the assembled state of the pot wall, the first end and the second end of the pot wall are connected by a connecting piece, the connecting piece being a connecting nail; the first end of the pot wall is provided with a first connecting hole, and the second end of the pot wall is provided with a second connecting hole; the connecting nail, at the same time, passes through the first connecting hole and the second connecting hole to connect the first end and the second end of the pot wall.

The first end of the pot wall is provided with a first positioning protrusion having a convex portion, and the second end of the pot wall is provided with a second positioning protrusion having a convex portion for engaging with the first positioning protrusion convex portion when the pot wall is assembled. The structure of the first positioning protrusion convex portion and the structure of the second positioning protrusion convex portion are the same as the structure of the upper clamping member or the lower clamping member or the clamping member formed by the combination of the upper clamping member and the lower clamping member.

The beneficial effects of the present invention are that the pot wall is provided with a clamping part, the pot bottom is provided with a clamping part, and the upper clamping part is clamped to the upper side of the clamping part and the lower clamping part is clamped to the lower side of the clamping part. When the pot is planted, the clamping part can effectively clamp the bottom of the pot to prevent the pot bottom from falling off.

The foregoing summary is illustrative only and is not intended to be in any way limiting. In addition to the illustrative aspects, embodiments, and features described above, further aspects, embodiments, and features will become apparent by reference to the following figures and the detailed description.

### BRIEF DESCRIPTION OF THE DRAWINGS

For a detailed description of the various embodiments, reference will now be made to the accompanying drawings in which:

FIG. 1 is a schematic structural view of the bottom of the planting pot in Example 1 of the present invention.

FIG. 2 is a bottom view of the bottom of the planting pot in Example 1 of the present invention.

FIG. 3 is a schematic view of the structure of the pot wall of the planting pot in Example 1 of the present invention.

FIG. 4 is a side view of the pot wall of the planting pot in Example 1 of the present invention.

FIG. 5 is a schematic diagram of integrated structure of the planting pot of Example 1 of the present invention.

FIG. 6 is an overall top view of the planting pot of Example 1 of the present invention.

FIG. 7 is a cross-sectional view taken along the A-A direction of FIG. 6, and the enlarged part is a schematic diagram of the connection structure between the pot wall and the pot bottom.

FIG. 8 is a schematic diagram of the pot wall stacking of five planting pots in Example 1.

FIG. 9 is a schematic diagram of the bottom stacking of five planting pots in Example 1.

FIG. 10 is a structural schematic diagram of the pot wall of the planting pot in Example 2 of the present invention.

FIG. 11 is a schematic diagram of the overall structure of the planting pot in Example 2 of the present invention.

FIG. 12 is a schematic diagram of the overall structure of the planting pot of Example 3 of the present invention.

FIG. 13 is a schematic diagram of the assembly of the planting pot in Example 3 of the present invention.

FIG. 14 is a schematic structural view of the bottom of the planting pot in Example 4 of the present invention.

FIG. 15 is a schematic diagram of the overall structure of the planting pot of Example 4 of the present invention.

FIG. 16 is an overall plan view of a planting pot of Example 4 of the present invention.

FIG. 17 is a cross-sectional view in the direction of B-B in FIG. 16, and the enlarged part is a schematic diagram of the connection structure between the pot wall and the pot bottom.

In the figures the following parts are shown: 101-first support plate, 102-second support plate, 103-third support plate, 104-fourth support plate, 105-Clamping hole, 106-flange, 111-first plate, 112-clamping portion, 121-reinforcing rib, 131-second through hole, 141-mounting groove, 201-first connecting hole, 202-second connecting hole, 203-connecting nail, 204-first positioning member, 205-second positioning member, 211-first wall plate 212-second wall plate, 213-third wall plate, 221-upper clamping member, 222-lower clamping member, 223-upper shielding member, 224-lower shielding member, 231-first through hole, 241-first positioning protrusion having a convex portion, 242-second positioning protrusion having a convex portion, 261-wave crest, and 262-wave trough.

### DETAILED DESCRIPTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be an example of the embodiment, and not intended to intimate that the scope of the disclosure, including the claims, is limited to that embodiment.

The present invention will be further described in detail below in conjunction with the drawings and specific embodiments. In order to highlight the focus of the present invention, some conventional equipment, devices, components and operations are omitted or only briefly described in this article. In this article, the inner side of the pot wall refers to the side of the pot wall facing the pot bottom in the assembled state of the pot wall and the pot bottom, and the outer side of the pot wall refers to the state in which the pot wall and the pot bottom are assembled, the side of the pot is wall facing away from the pot bottom.

### EXAMPLE ONE

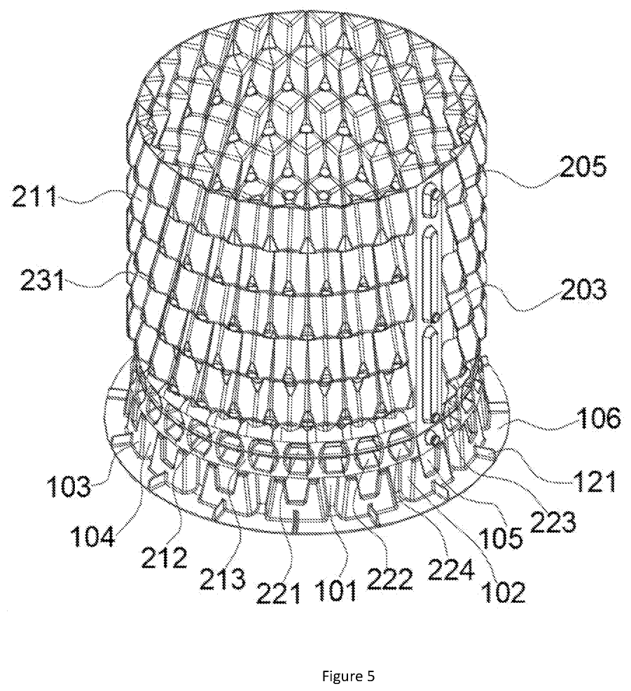

Referring to FIGS. 5 to 7, a planting pot includes a pot bottom and a pot wall.

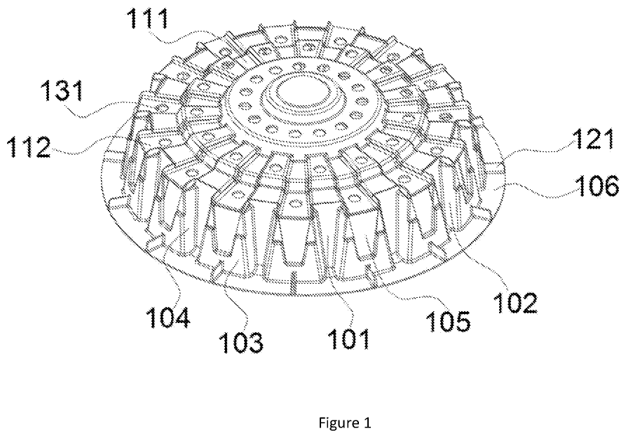

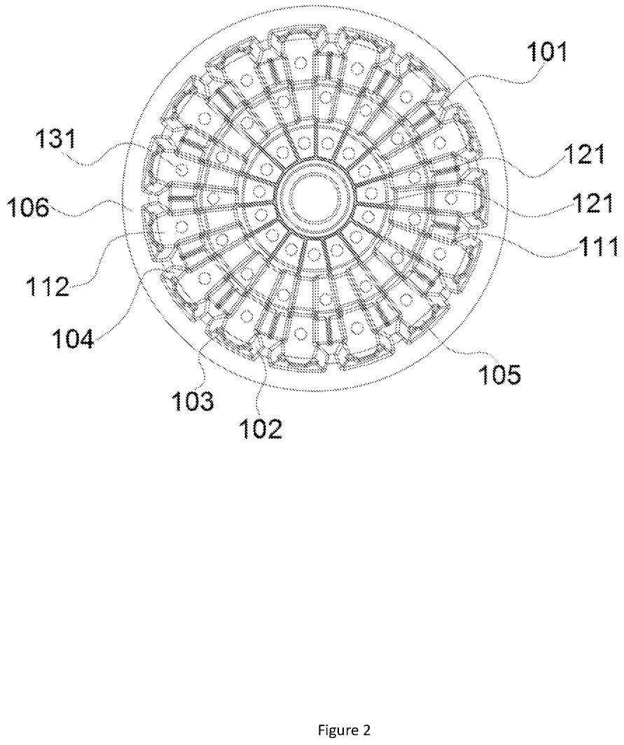

Referring to FIGS. 1 and 2, the pot bottom includes a top plate and a support frame, and the top of the support frame is fixedly connected to the outer edge of the top plate, and the support frame is surrounded by a platform with a narrow upper and a wide bottom, which makes the bottom structure of the pot more stable and can be stacked more compactly, occupying smaller using space. In a preferred embodiment, the support frame is surrounded to form a truncated cone shape with a narrow top and a wide bottom. The support frame separates the substrate from the soil to prevent soil-borne diseases and affect the growth quality of crops. The bottom of the support frame is provided with an outward flange 106 to increase the contact area between the bottom of the support frame and the ground, prevents the planting pot from sinking into the soil, and make the support frame's function of separating the soil invalid. Reinforcing ribs 121 are provided on the flange 106 to make the bottom structure more stable. The support frame adopts the structure of upper narrow and lower width, and adopts the flange 106 structure and ground support, which can optimize the structure of the product mold, reduce the difficulty of production, and can also solve the pot bottom support frame with the upper and lower widths or the same width. The height is limited by the shortcomings of the mold structure. The bottom of the pot has a hollow structure.

Referring to FIGS. 1 & 2, the top plate includes a first plate 111 and a number of clamping portions 112. The first plate 111 is used to receive the substrate and crops in the pot, and the clamping portion 112 is used in the assembled state of the pot wall and the bottom of the pot. The lower part is clamped with the pot wall, the clamping portions 112 are arranged at intervals on the peripheral side of the first plate 111, and the clamping portions 112 extend outwardly. In a preferred embodiment, the clamping portion 112 is a flat plate. The support frame includes several support plate groups; the support plate group includes a first support plate 101, a second support plate 102, a third support plate 103 and a fourth support plate 104. The top of the first support plate 101 and the first plate 111 is fixedly connected, the tops of the second support plate 102 and the fourth support plate 104 are respectively fixedly connected to the two ends of the clamping portion 112; the first end of the first support plate 101 is fixedly connected to the second end of the fourth support plate 104, the second end of the first support plate 101 is fixedly connected to the first end of the second support plate 102, the first end of the fourth support plate 104 and the second end of the second support plate 102 both extend outward, and the second end of the second support plate 102 is fixedly connected to the first end of the third support plate 103, and the second end of the third support plate 103 is fixedly connected to the first end of the fourth support plate 104 of the next supporting plate group. The third support plate 103 is located outside the first support plate 101, so that the supporting frame forms a concave-convex structure, thereby making the pot bottom supporting structure more stable. A clamping hole 105 is opened on the top of the third support plate 103. In the 1st preferred embodiment, the clamping hole 105 is wide at the top and narrow at the bottom to make the bottom structure more stable. The third support plate 103 is also provided with a wrinkle to make the pot bottom structure more stable and also play a role in positioning the pot wall. When installing, align the lower end of the pot wall with the folds to install the pot wall more quickly. In a preferred embodiment 1 and 2, the top plate is provided with fifteen clamping portions 112; the support frame is provided with fifteen support plate groups. In a preferred embodiment, the pot bottom is integrally formed.

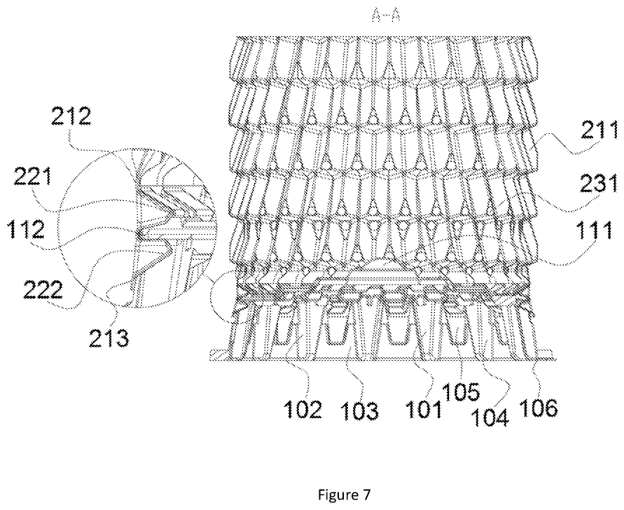

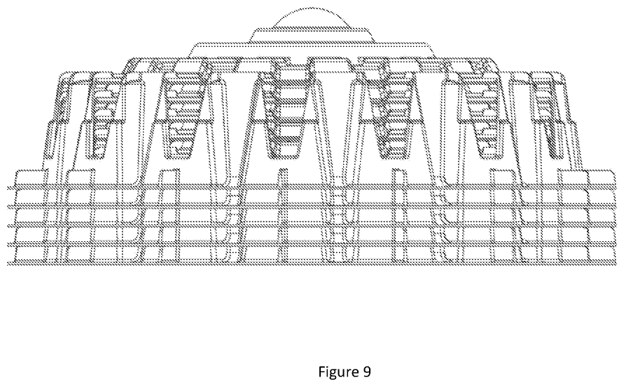

Referring to FIGS. 1 and 2, the top plate is provided with a number of second through holes 131 for ventilation to prevent moisture in the planting pot from affecting the crop growth. In the preferred embodiment 1 and 2, the top plate is provided with three circles of second through holes 131, the number of second through holes 131 in each circle is fifteen. Referring to FIG. 1, FIG. 7 and FIG. 9, the top plate has a middle-high and low edge the stepped structure makes the pelvic floor more stable and has stronger load-bearing capacity. In addition, the outermost edge is at the lowest point, and the matrix structure is relatively loose which also allows the excess water in the planting pot to flow in the matrix to the edge of the top plate due to its own gravity, and flow out from the gap between the top plate and the pot wall, preventing the planting pot. The internal humidity is too high. Referring to FIG. 1 in a preferred embodiment, the edge of clamping portion 112 is rounded, so that the water can flow out more easily, because the water is not easy to flow out from the sharper edge due to the surface tension and siphon phenomenon. In the 1st preferred embodiment, the top plate is spaced upwardly to make the top plate structure more stable and improve the load-bearing capacity of the top plate. In the 2nd preferred embodiment, the bottom of the top plate is provided with reinforcing ribs 121, so that the bottom structure is more stable and has a stronger load-bearing capacity.

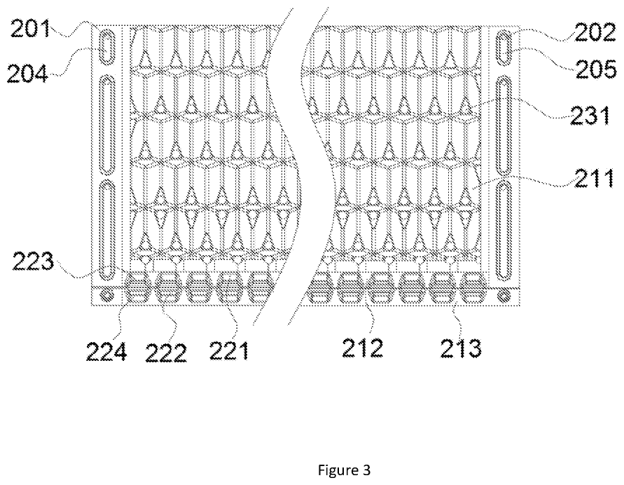

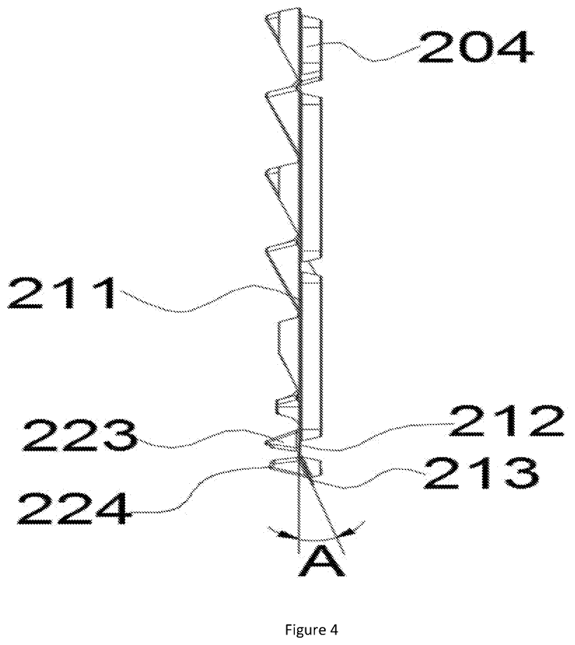

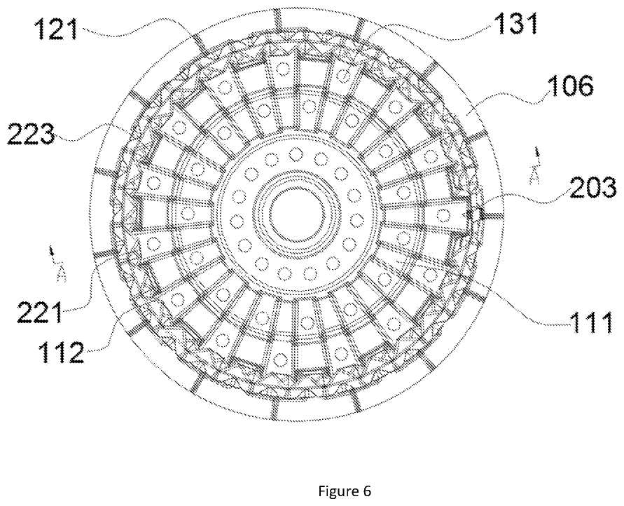

Referring to FIGS. 5 and 6, in the assembled state of the pot wall and the pot bottom, the pot wall surrounds the side wall of the planting pot. The first end and the second end of the wall in a flat state are connected by a connecting piece, and the connecting piece is a connecting nail 203. Referring to FIG. 3 and FIG. 4. The first end of the pot wall in the flat state is provided with a first positioning member 204, and the second end of the pot wall in the flat state is provided with a second positioning member 205, the first positioning member 204 and the second positioning member 205 have the same structure, and are formed by protruding outward from the wall of the pot; The first positioning member 204 is provided with a first connecting hole 201, the second positioning member 205 is provided with a second connecting hole 202, and the connecting nail 203 passes through the first connecting hole 201 and the second connecting hole 202 at the same time, and connects the first end and the second end of the pot wall in a flat state. Using the connecting nail 203 for connection can make the connection between the first end and the second end of the pot wall stronger. During installation, the second positioning member 205 is sleeved on the first positioning member 204 to align the first connecting hole 201 with the second connecting hole 202, so that farmers do not need to deliberately compare the first connecting hole 201 with the first connecting hole 201 when installing the pot wall. The position of the second connecting hole 202 saves installation time.

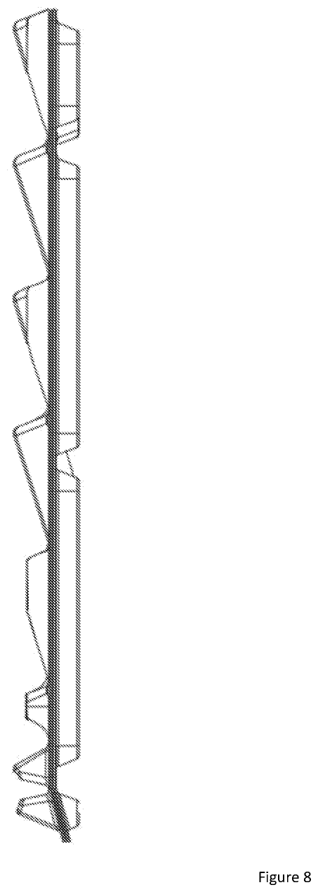

Referring to FIGS. 3 and 4, the pot wall includes a first wall plate 211, a second wall plate 212 and a third wall plate 213, the bottom of the first wall plate 211 is fixedly connected to the top of the second wall plate 212, and the bottom of the second wall plate 212 is fixedly connected to the top of the third wall plate 213. The bottom of the pot wall is provided with a clamping piece group for clamping the pot bottom. The clamping piece group includes a plurality of clamping pieces, and the clamping piece includes at least one of the upper clamping member 221 and the lower clamping member 222. The clamping member group includes at least three upper clamping members 221 and three lower clamping members 222. The clamping member 222, the three upper clamping members 221 form an acute triangle, and the three lower clamping members 222 form an acute triangle. In a preferred alternative embodiment, the clamping member includes an upper clamping member 221 and a lower clamping member 222 at the same time to make the clamping connection stronger. The upper clamping member 221 is fixedly disposed on the second wall plate 212, and the lower clamping member 222 is fixedly disposed on the third wall plate 213. Referring to FIGS. 4 and 8, in a preferred embodiment, the upper clamping member 221 is formed by the second wall plate 212 protruding toward the inner side of the pot wall, and the lower clamping member 222 is formed by the third wall plate 213 protruding toward the inner side of the pot wall, so that the pot wall can be stacked more compactly, occupying a smaller space, and saving materials for manufacturing the upper clamping member 221 and the lower clamping member 222. Referring to FIG.7, in the assembled state of the pot wall and the pot bottom, the upper clamping member 221 is clamped to the upper side of the clamping portion 112, the lower clamping member 222 is clamped to the lower side of the clamping portion 112. In the FIGS. 3, 5 and 6 of the embodiment, where the clamping portions 112 are spaced apart and extend outward, in order to block the gap between two adjacent clamping portions 112 and prevent the matrix from leaking, the pot wall is also provided a number of shields, and the number of shields is the same as the number of the clamping portions 112. The shielding piece and the clamping piece are alternately arranged. Referring to FIG. 3, FIGS. 5 and 6, in a preferred embodiment, the structure of the shield is the same as that of the clamping member, and the shield includes at least one of the upper shielding member 223 and one of the lower shielding member 224; the structure of the upper shielding member 223 is the same as the structure of the upper clamping member 221, and the structure of the lower shielding member 224 is the same as that of the lower clamping member 222, so that the shielding member can be used as a clamping member, and the clamping member can be used as a shielding member so that farmers do not have to deliberately compare the position of the clamping member and the shielding member when installing the pot wall and save installation time. In a preferred embodiment, the shielding member includes an upper shielding member 223 and a lower shielding member 224 at the same time, so that the shielding member can more firmly clamp the pot bottom when used as a clamping member. In a preferred embodiment, the upper shielding member 223 is formed by the second wall plate 212 protruding toward the inner side of the pot wall, and the lower shielding member 224 is formed by the third wall plate 213 protruding toward the inner side of the pot wall. In a preferred embodiment, the clamping piece group includes fourteen clamping pieces; and the pot wall is provided with fifteen blocking pieces.

Referring to FIGS. 4 and 7, in a preferred embodiment, the third wall plate 213 is inclined outward when the pot wall is flat and the angle of the outward inclination, namely the angle A, is 12-18° , preferably, the angle A is 15° ;referring to the enlarged part of FIG. 7, the angle between the pot wall and the pot becomes smaller to 0-5° , when the bottom is assembled, the third wall plate 213 surrounds the pot bottom, the third wall plate 213 fits tightly with the pot bottom, and the third wall plate 213 is inclined outward. The purpose of this arrangement is to make the upper surface of the lower clamping member 222 form an upward hook shape after being surrounded by the third wall plate 213 so that the clamping between the lower clamping member 222 and the top plate is closer. If the third wall plate 213 is in the flat state of the pot wall, then it does not incline outward, and the surface of the lower clamping member 222 is an upward hook, so that the pot wall cannot be demolded.

Referring to FIGS. 3 to 5, the first wall plate 211 has a wave-shaped structure to improve the strength of the first wall plate 211, and at the same time the wave-shaped structure can enhance the supporting effect of the first wall plate 211 on the matrix, preventing the matrix from sinking due to gravity, and making the matrix more dispersed. Even, so that the roots of the crops in the planting pots grow more evenly. The first wall plate 211 is provided with a plurality of first through holes 231, used for ventilation to prevent excessive humidity in the planting pot. Due to the influence of the gravity of the water, the humidity of the substrate in the planting pot increases from top to bottom to make the roots of the crops in the planting pot grow more evenly and the produce crop yield higher. Referring to FIG. 3, in a preferred embodiment, the number of the first through holes 231 increases sequentially from top to bottom. In a preferred embodiment, the outer layer of the pot wall is white, to reflect the sunlight to prevent the temperature in the planting pot from being too high; the inner layer of the pot wall is black to prevent the penetrating light of the pot wall from affecting the cultivation of the planting pot and the root system of the thing grows. In a preferred embodiment, the pot wall is integrally formed.

When in use, referring to FIGS. 5 to 7, the pot wall is made to surround the pot bottom, the lower clamping member 222 extends into the clamping hole 105, and the upper clamping member 221 is clamped to the upper side of the clamping portion 112, the lower clamping member 222 is clamped to the lower side of the clamping portion 112, the upper clamping member 221 and the lower clamping member 222 cooperates to clamp the top plate to make the connection between the pot wall and the pot bottom more firmer; the second positioning member 205 is sleeved on the first positioning member 204, then, the first connecting hole 201 and the second connecting hole 202 can be aligned, and then the connecting nail 203 can be inserted into the first connecting hole 201 and the second connecting hole 202 to connect the first end and the second end of the pot wall to obtain a complete planting pot; put the substrate and crops into the planting pot, and then add the nutrient solution to cultivate crops.

When disassembling, remove the connecting nail 203, unfold the pot wall, and separate the pot wall from the bottom of the pot to disassemble the planting pot. During storage and transportation, referring to FIGS. 8 and 9, stacking the pot wall and the pot bottom can reduce the space occupied by the planting pot and reduce storage and logistics cost.

### EXAMPLE 2

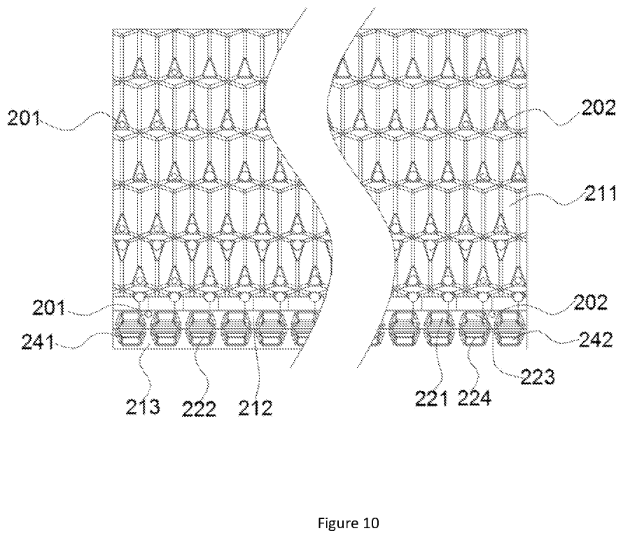

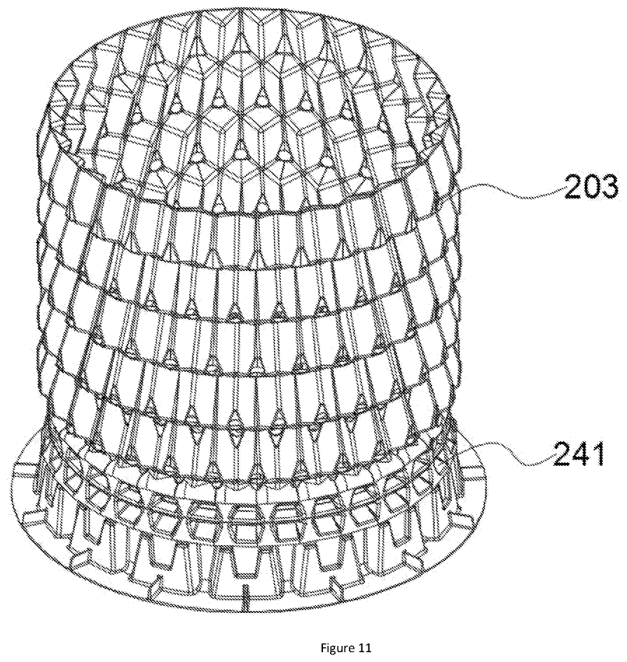

Referring to FIGS. 10 and 11, the technical solution is roughly the same as the first embodiment, except that the pot wall is flat, the first positioning member 204 and the second positioning member 205 are not provided at both ends of the state, and the first connecting hole 201 is directly opened on the first side of the pot wall. At one end, the second connecting hole 202 is directly opened at the second end of the pot wall; the first end of the pot wall is provided with a first positioning protrusion 241. The second end of the pot wall is provided with a second positioning protrusion 242. In a preferred embodiment, the first positioning protrusion 241 and the second positioning protrusion 242 are the same as the structure of the clamping member. During installation, the second positioning protrusion 242 is sleeved on the first positioning protrusion 241, the connecting nail 203 is passed through the first connecting hole 201 and the second connecting hole 202 at the same time, and one end is connected to the second end, and the second positioning protrusion 242 also serves to clamp the bottom of the pot. In addition, when the length of the pot wall is longer, the second positioning protrusion 242 is sleeved on the clamping piece to make it fit the bottom of the pot. In another preferred embodiment, the first positioning convex structure of the portion 241 and the second positioning protrusion 242 are the same as the structure of the shield; when installed, the second positioning protrusion 242 may also play a shielding role. When the length of the pot wall is long, the second positioning protrusion 242 can be sleeved on the shielding member to make it fit the pot bottom. In another preferred embodiment, the structures of the first positioning protrusion 241, the second positioning protrusion 242, the clamping member and the shielding member are all the same; during installation, the second positioning protrusion 242 can play a role of clamping or blocking; when installing the pot wall, farmers do not need to deliberately compare the positions of the first positioning protrusion 241, the second positioning protrusion 242, the clamping member and the shielding member, saving installation time; when the length of the pot wall is longer, the second positioning protrusion 242 can be sleeved on the clamping member or the shielding member to make it fit the bottom of the pot.

### EXAMPLE 3

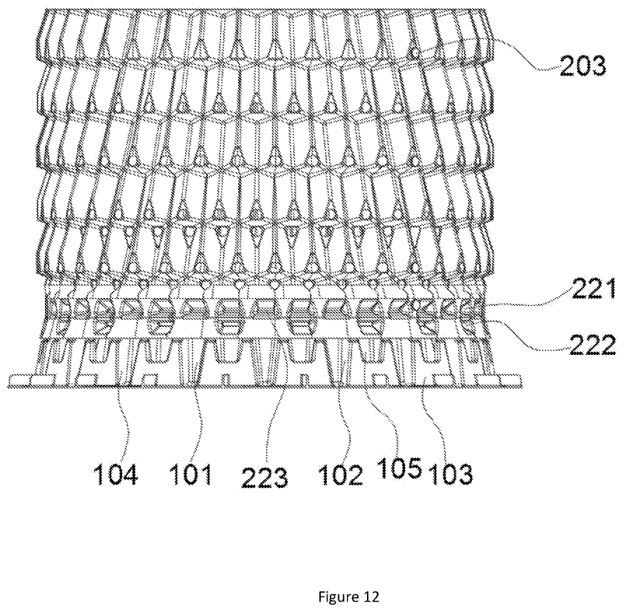

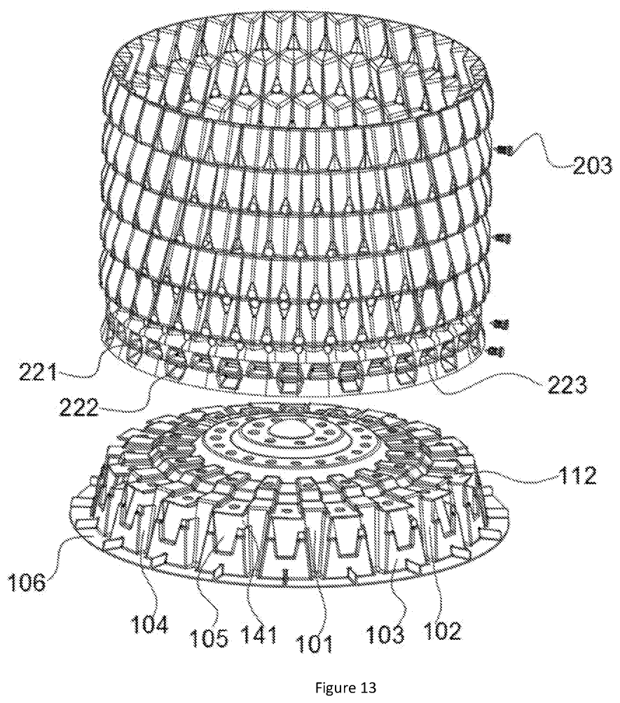

Referring to FIGS. 12 and 13, the technical solution is substantially the same as that of the second embodiment, except that: the shielding member only includes an upper shielding member 223, and the upper clamping member 221 are arranged alternately; the upper part of the fourth support plate 104 and/or the upper part of the second support plate 102 is provided with a mounting groove 141 through which the lower clamping member 222 passes.

Referring to FIG. 13, during installation, the pot wall can be first surrounded to connect the first end and the second end of the pot wall; the gap between the lower clamping member 222 and two adjacent clamping portions 112 is aligned, and the surrounding pot wall is sleeved on the pot bottom; rotate the pot wall so that the lower clamping member 222 passes through the mounting groove 141 and enters the clamping hole 105, so that the upper clamping member 221 is clamped above the clamping portion 112, and the lower clamping member 222 is clamped under the clamping portion 112 to obtain a complete planting pot; the installation method in Embodiment 1 can also be adopted, that is, the wall of the pot surrounds the bottom of the pot, the lower clamping member 222 extends into the clamping hole 105, and the upper clamping member 221 is clamped on the upper side of the clamping portion 112, and the lower clamping member 222 is clamped on the lower side of the clamping portion 112, and then both ends of the pot wall are connected and fixed.

When disassembling, you can first rotate the pot wall to separate the surrounding pot wall from the pot bottom, and then unfold the pot wall to complete the disassembly; or unfold the pot wall, and then separate the pot wall from the pot bottom to complete the disassembly.

### EXAMPLE 4

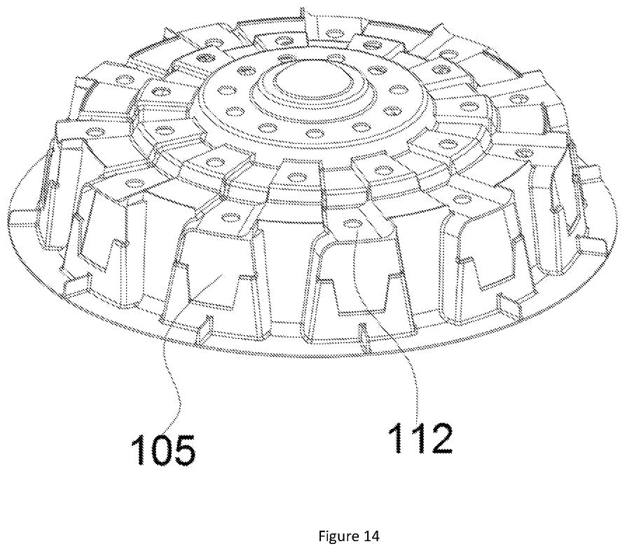

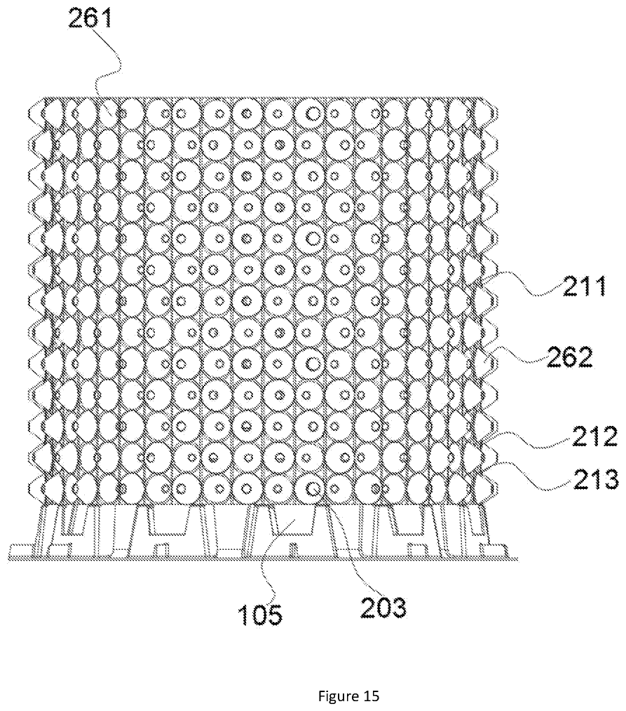

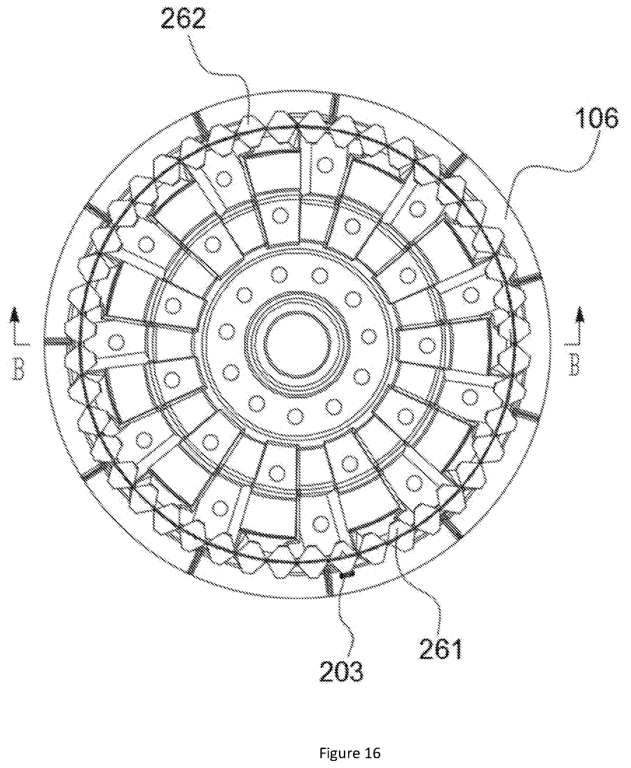

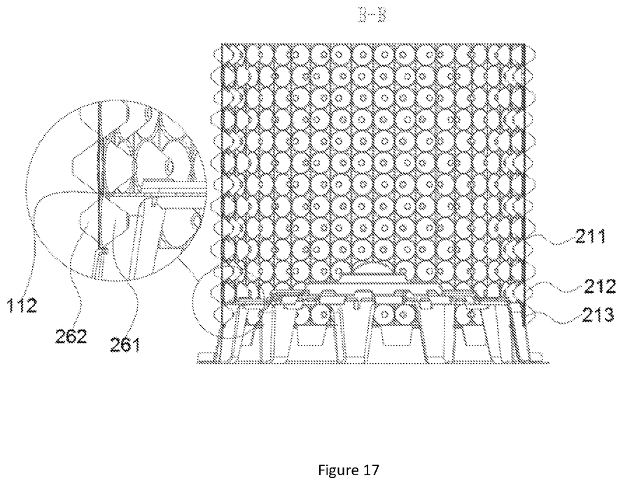

FIGS. 14 to FIG. 17, the technical solution is roughly the same as the second embodiment, the difference is: refer to FIG. 14 and FIG. 16, the bottom of the pot is provided with eleven support plate groups and eleven clamping portions 112, the clamping portions 112 are arc-shaped plates; the top plate is provided with three circles, the second through holes 131, the number of the second through holes 131 in each circle is eleven; and referring to FIGS. 15 and 17, the first wall plate 211, the second wall plate 212 and the third wall plate 213 has the same structure, and all have a wave-shaped structure, so that the pot wall has a wave-shaped structure as a whole: the wave crest 261 of the wave-shaped structure is formed by protruding inward from the pot wall, the wave trough 262 of the wave-shaped structure is formed by the outward depression of the pot wall: referring to FIG. 17, in the assembled state of the pot wall and the pot bottom, the wave crest 261 at the bottom of the pot wall can be used as the clamping member in the first to third embodiments. The wave crest 261 located on the second wall plate 212 plays the role of the upper clamping member 221, which is clamped above the clamping portion 112. The wave crest 261 of the third wall plate 213 functions as the lower clamping member 222, passes through the clamping hole 105, and is clamped under the clamping portion 112; the crests 261 and troughs 262 are provided with holes for ventilation; referring to FIGS. 15 and 16, the crests 261 located at both ends of the pot wall and trough 262 also play a role in positioning. The holes at both ends of the pot wall also function as connecting holes. When surrounding the pot wall, the wave crest 261 at the first end of the pot wall is superimposed with the wave crest 261 at the second end of the pot wall and the wave trough 262 at the first end of the pot wall is overlapped with the second end of the pot wall. The connecting nail 203 is simultaneously passed through the hole at the first end of the pot wall and the hole at the second end of the pot wall to connect the first end and the second end of the pot wall.

During installation, the shilling pot wall surrounds the pot bottom, and the crest 261 of the second wall plate 212 is clamped on the upper side of the clamping portion 112. The wave crest 261 of the third wall plate 213 extends into the clamping hole 105 and is clamped on the lower side of the clamping portion 112, and then connected to the two ends of the pot wall. When disassembling, unfold the pot wall first and then separate the pot wall from the pot bottom to complete the disassembly.

It should be understood that although the present invention has been described in more detail through specific implementations, however, these descriptions do not limit the scope of the patent of the present invention, and what is made on this basis does not exceed the protection scope of the claims. Changes in form and details fall within the protection scope of the present invention.

We claim:

1. A type of planting pot includes a pot wall and a pot bottom, and further comprising:
a bottom of the pot wall is provided with a clamping piece group, that includes a plurality of upper clamping members (221) and a plurality of corresponding lower clamping members (222), and each of the upper clamping members (221) is located above one of the lower clamping members (222);
the pot bottom is provided with a plurality of clamping portions (112) for clamping the pot bottom to the pot wall such that when the pot wall and the pot bottom are assembled together, each of the upper clamping members (221) is clamped on an upper side of one of the clamping portions (112), and the corresponding lower clamping member (222) is clamped on a lower side of the clamping portions (112).

2. The planting pot according to claim 1, wherein the pot wall comprises a first wall plate (211), a second wall plate (212), and a third wall plate (213), a bottom of the first wall plate (211) is connected to a top of the second wall plate (212), and a bottom of second wall plate (212) is connected to a top of the third wall plate (213); the plurality of upper clamping members (221) are arranged on the second wall plate (212) and the plurality of lower clamping members (222) are arranged on the third wall plate (213).

3. The planting pot according to claim 2, wherein, the third wall plate (213) is inclined outward when the pot wall is flat, and the angle of the outward inclination is 12-18° ; when the third wall plate (213) is in a state where the pot wall surrounds the pot bottom, the outwardly inclined angle is 0-5°.

4. The planting pot according to claim 2, wherein the upper clamping member (221) is formed by the second wall plate (212) protruding towards the inner side of the pot wall; the lower clamping member (222) is formed by the third wall plate (213) protruding towards the inner side of the pot wall.

5. The planting pot as in any of the preceding claims, in which the bottom of the pot comprises a first plate (111) and a support frame; the clamping portions (112) are arranged on the first plate (111) at intervals, and the clamping portions (112) extend outwards; the clamping portions (112) are connected with the first plate (111) to form a top plate and a top of the support frame is connected with the top plate.

6. The planting pot according to claim 5, characterized in that the pot wall is further provided with a plurality of shielding members for shielding a gap between two adjacent clamping portions (112) in the assembled state of the pot wall and the bottom of the pot, wherein the number of the shielding members is the same as the number of the clamping portions (112).

7. The planting pot according to claim 5, wherein the support frame comprises a plurality of support plate groups, and each of the support plate groups includes a first support plate (101), a second support plate (102) and a fourth support plate (104), a top of the first support plate (101) is connected to the top plate, and a first end of the first support plate (101) is connected to a second end of the fourth support plate (104); a second end of the first support plate (101) is connected to a first end of the second support plate (102), and a first end of the fourth support plate (104) and a second end of the second support plate (102) extend outwards.

8. The planting pot according to claim 7, characterized in that an upper part of the fourth support plate (104) and/or an upper part of the second support plate (102) is provided with a mounting groove (141) for one of the lower clamping members (222) to pass through.

9. The planting pot according to any one of claims 1, 2, 3 and 4, characterized in that, in the assembled state of the pot wall, a first end and a second end of the pot wall are connected by a connecting piece, the connecting piece being a connecting nail (203); the first end of the pot wall is provided with a first connecting hole (201), the second end of the pot wall is provided with a second connecting hole (202); the connecting nail (203) passes through the first connecting hole (201), and the second connecting hole (202) to connect the first end and the second end of the pot wall.

10. The planting pot according to claim 9, characterized in that the first end of the pot wall is provided with a first positioning protrusion (241), and the second end of the pot wall is provided with a second positioning protrusion (242) which is used for clamping with the first positioning protrusion (241) when the pot wall is assembled on the pot bottom;
wherein, the structure of the first positioning protrusion (241) and the second positioning protrusion (242) are the same as the structure of the upper clamping member (221) or the lower clamping member (222) or the same as the combination of the upper clamping member (221) and the lower clamping member (222).
